(19) United States
(12) Patent Application Publication
(10) Pub. No.: US 2007/0279851 A1
(43) Pub. Date: Dec. 6, 2007

(54) Flexible enclosure for a motorized mount

(76) Inventors: Sung Oh, West Covina, CA (US); Gyu Chang Kim, Suwon Si (KR); Hang Gu Yeo, Siheung Si (KR)

Correspondence Address: SUNG I. OH, PROFESSIONAL LAW CORPORATION, 710 QUAIL VALLEY LANE, WEST COVINA, CA, 91791, US

(21) Appl. No.: 11/807,949

(22) Filed: May 30, 2007

Related U.S. Application Data
(60) Provisional application No. 60/809,801, filed on May 30, 2006.

(51) Int. Cl. G06F 1/16

(52) U.S. Cl. 361/681

(57) ABSTRACT

A flexible enclosure is adapted to enclose one or more motorized actuators in a mounting system. The mounting system is designed to adjust the viewing angle of a flat panel television or monitor. The flexible enclosure has a proximal end and a distal end. The proximal end may be coupled to a base plate that is adapted to couple to a wall. The distal end of the flexible enclosure may extend and may swivel and/or tilt in a sliding manner to follow the movement of the monitor.

### RELATED APPLICATIONS

This application claims priority to a US provisional application Ser. No. 60/809,801 filed May 30, 2006, and a U.S. provisional application Ser. No. 60/844,932, filed Sep. 15, 2006, which are both hereby incorporated by reference.

### FIELD OF THE INVENTION

This invention is generally directed to a flexible enclosure that encloses a motorized mount to prevent foreign objects from interfering with the moving mechanical parts of the motorized mount. In particular, the flexible enclosure has one end that is adapted to slide in the vertical and/or horizontal direction to reduce the resistance of the flexible enclosure during the movement of the motorized mount.

### BACKGROUND OF THE INVENTION

Flat panel monitors such as computer monitors, LCD, plasma, slim televisions, and the like (collectively referred to as “monitor(s)”) are becoming popular because they can be mounted onto a wall to save floor space and for their aesthetically pleasing appearance. In particular, monitors may be mounted to a wall with a motorized mount that can extend the monitor from the wall and swivel and/or tilt the monitor. The motorized mount allows the viewer to adjust the viewing angle of the monitor with a remote control. With motorized mounts, however, the motorized actuators may be exposed such that when a foreign object interferes with the movement of the actuator, the actuator and/or the foreign object may get damage. As such, there is a need to shield the motorized actuators from interfering with the movement of the actuators.

### SUMMARY OF THE INVENTION

This invention is directed to a flexible enclosure that is adapted to enclose one or more motorized actuators in a mounting system. In particular, the mounting system is designed to adjust the viewing angle of a flat panel television or monitor. In this application, the mounting system is adapted to couple to the backside of the monitor and mount to a wall. The mounting system may be remotely controlled to extend the monitor from the wall at a predetermined distance and may swivel (side to side) and/or tilt (up and down) the monitor.

The flexible enclosure has a proximal end and a distal end. The proximal end may be coupled to a base plate that is adapted to couple to a wall. The distal end of the flexible enclosure may extend and may swivel and/or tilt in a sliding manner to follow the movement of the monitor.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows a motorized mounting system in reference to X, Y, and Z axes.

FIG. 2 is cross-sectional side view of the mounting system along the line 2 shown in FIG. 1.

FIG. 3 shows a cross-sectional side view of the mounting system in a retracted position along the line 2 shown in FIG. 1.

FIG. 4 shows a cross-sectional view of the link along the line 4 shown in FIG. 2.

FIG. 5 shows a proximal end of a second link for one of the actuators pivotally coupled to its respective universal pivot joint.

FIG. 6 shows a cross-sectional view of the universal pivot joint along the line 6 in FIG. 5.

FIG. 7 shows a bracket system adapted to pivotally couple the distal ends of the three actuators along their respective locations in the mounting surface.

FIG. 8 shows a rotatable joint that may be used to pivot the distal ends of the three actuators.

FIG. 9 shows a socket having a circular cavity adapted to receive the round head to rotate therein.

FIG. 10 is a perspective view of the bracket system attached to the backside of a monitor.

FIG. 11 is a schematic side view of the mounting system of FIG. 1 to illustrate that the rotatable joint for the middle actuator slides along an elongated slot when the mounting system tilts downward.

FIG. 12 is a schematic side view of the mounting system of FIG. 1 to illustrate that the rotatable joint for the middle actuator slides along an elongated slot when the mounting system tilts upward.

FIG. 13 shows a side view of the mounting system in a retracted position.

FIG. 14 shows a side view of the mounting system supporting a monitor in a tilted upward position.

FIG. 15 shows a side view of the mounting system supporting a monitor in a tilted downward position.

FIG. 16 shows a top view of the mounting system supporting a monitor swiveled to the right side.

FIG. 17 shows a top view of the mounting system supporting a monitor swiveled to the left side.

FIG. 18 shows disassembled perspective view of the mounting system of FIG. 1 that has been inverted.

FIG. 19 shows a side view of a flexible enclosure in an extended and upright position.

FIG. 20 shows a cross-sectional view along the line 20-20 of FIG. 19.

FIG. 21 shows a side view of the flexible enclosure in an extended and tilted down position.

FIG. 22 shows a side view of the flexible enclosure in an extended and tilted up position.

FIG. 23 shows a top view of the flexible enclosure in an extended and upright position.

FIG. 24 shows a top view of a flexible enclosure in an extended and swiveled to the right position.

### DETAIL DESCRIPTION OF THE INVENTION

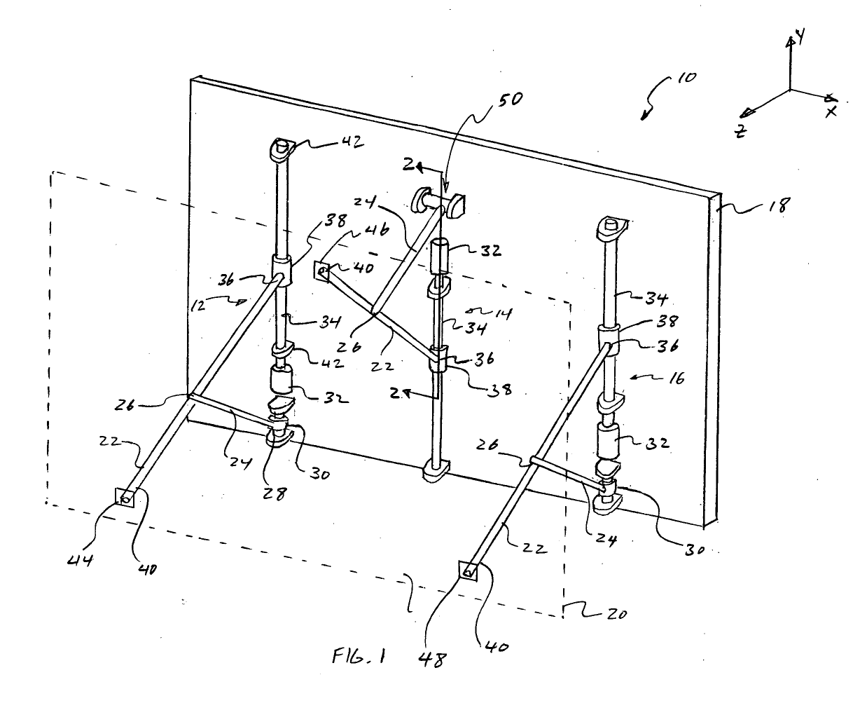

FIG. 1 shows a perspective view of a mounting system 10 in reference to X, Y, and Z axes. The mounting system 10 includes a first actuator 12, a second actuator 14, and a third actuator 16 between a reference plane 18 and a mounting surface 20. The first and third actuators 12 and 16 may be substantially similar with respect to each other, with the second actuator 14 having a minor difference with the first and third actuators 12 and 16, as discussed in more detail below. The second actuator 14 is between the first and third actuators 12 and 16, and it is substantially inverted relative to the first and third actuators 12 and 16. The three actuators 12, 14, and 16 may be activated independently to extend, retract, swivel (side to side), and/or tilt (up and down) the mounting surface 20 relative to the reference plane 18, as explained in more detail below.

Each of the actuators may have a first link 22 and a second link 24. The second link 24 may be shorter or about one-half the length of the first link 22, and the distal end 26 of the second link 24 may be pivotally coupled to the first link 22 substantially along its midpoint. The proximal end 36 of the second link 24 is coupled to a universal joint 30 that is adapted to pivot about the Y-axis, as discussed in more detail below.

Each of the actuators may have a motor 32 that is coupled to a screw 34 to rotate the screw about its longitudinal axis. In this example, the motor 32 may be located substantially aligned with the longitudinal axes of its screw 34. In addition, the motor 32 may be located between the screw 34 and the universal pivot joint 30. The screw 34 may be supported by support brackets 42 to couple the screw to the reference plane 18.

The proximal end 36 of the first link 22 may be pivotally coupled to a sleeve 38. The sleeve 38 may be adapted to move or slide along the longitudinal axis of the screw 34 as the screw 34 is rotated by the motor 32. The sleeve 38 may have a threaded opening adapted to engage with the screw 34. As such, as the screw 34 rotates, the sleeve slides along the screw 34. The two sleeves 38 for the first and third actuators 12 and 16 may turn about the Y-axis around their respective screws. The sleeve 38 for the second actuator 14, however, may be substantially prevented from lateral or side to side movement by the hinge 50, as explained in more detail below. As the sleeve 38 slides along the screw 34, the distal end 40 of first link 22 extends or retracts relative to the reference plane 18 depending on the rotational direction of the screw 34. For instance, as the sleeve 38 for the first actuator 12 slides along the screw 34 in the positive Y-axis direction, the distal end 40 of the first actuator 12 retracts toward the reference plane 18. Conversely, as the sleeve 38 for the first actuator 12 slides along the screw 34 in the negative Y-axis direction, the distal end 40 of the first actuator 12 extends away form the reference plane 18.

Alternatively, the sleeve 38 may be motorized to move along the longitudinal axis of the screw 34 that is fixed. Note that any other apparatus or method known to one skilled in the art may be utilized to slide a sleeve along the shaft, screw, or any other line.

With the second actuator 14 inverted relative to the first and third actuators 12 and 16, the three distal ends 40 of the three actuators 12, 14, and 16 may form a triangular configuration with respect to each other. The three distal ends 40 of the three actuators 12, 14, and 16 may be adapted to rotate relative to the mounting surface 20 along the three locations 44, 46, and 48, respectively. By independently adjusting the distance between the three locations 44, 46, and 48 and the reference plane 18, the mounting surface 20 may be moved from a first position to a second position, where the second position may be extended, retracted, swiveled, and/or titled relative the reference plane 18. For instance, by extending the location 46 relative to the locations 44 and 48, the mounting surface 20 may be tilted downward or tilted counter-clockwise about the YZ-plane; or by extending the location 44 and retracting the location 48, the mounting surface 20 may swivel in the counter-clockwise direction about the XZ-plane.

In one of many applications, the reference plane 18 may be adapted to couple to a wall and the mounting surface 20 may be adapted to couple to a monitor and a variety of apparatuses. Alternatively, the mounting surface 20 may be adapted to couple to a wall and the reference plane 18 may be adapted to couple to a monitor or a variety of apparatuses. As such, the reference plane 18 may be a fixed surface and the mounting surface 20 may be a movable surface; and, alternatively, the mounting surface 20 may be a fixed surface and the reference plane 18 may be a moveable surface.

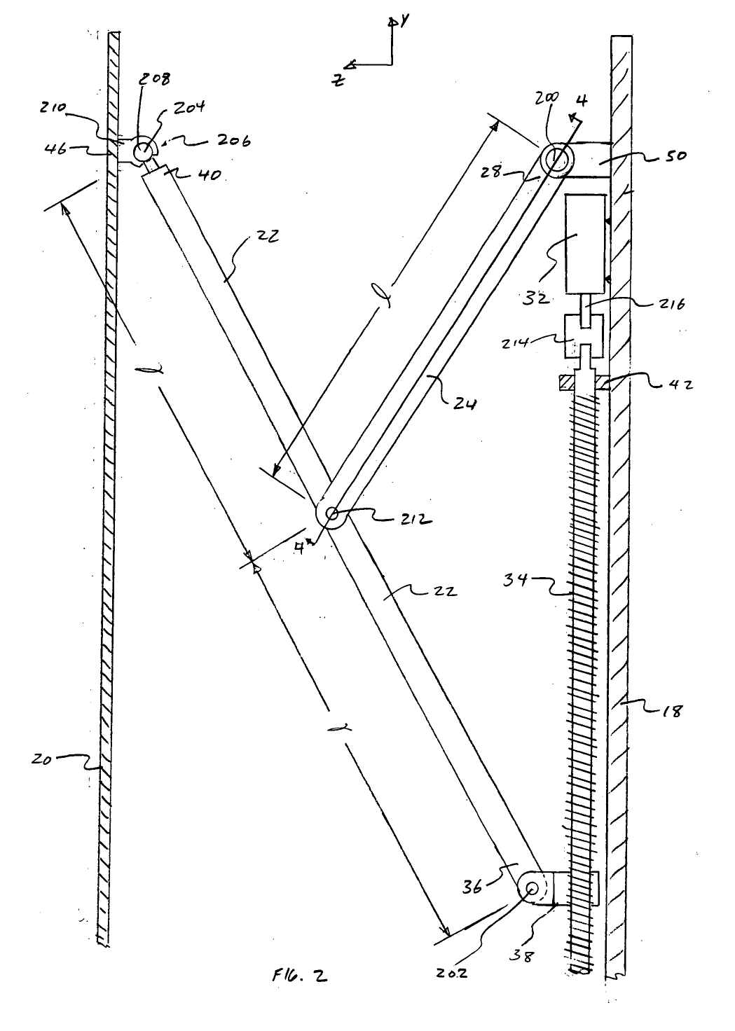

FIG. 2 is cross-sectional side view of the mounting system 10 along the line 2 shown in FIG. 1. The proximal end 28 of the link 24 may pivot about a pivot point 200 relative to the hinge 50, as described in more detail below. The proximal end 28 of the link 22 may pivot about a pivot point 202 relative to the sleeve 38, and the distal end 40 of the link 22 may pivot about a pivot point 204. The pivot point 204 may be a rotatable joint 206, where the round head 208 is within a socket 210 to allow the round head 208 to rotate within the socket 210. The round head 208 may be coupled to the distal end 40 of the first link 22. The link 24 may be pivotably coupled to the link 22 at about its midpoint 212 between the pivot points 202 and 204. In addition, the length of the link 22, as defined by the distance between the two pivot points 202 and 204, may be about twice as long as the length of link 24, as defined by the distance between the two pivot points 200 and 212. This allows the mounting surface 20 to extend from the reference plain 18 substantially along the Z-axis with nominal, if any, movement along the Y-axis.

The screw 34 may be supported by one or support mounts 42. The support mounts 42 may be adapted to allow the screw 34 to rotate along its longitudinal axis or along the Y-axis. The motor 32 may be located between the hinge 50 and the screw 34 to turn the screw 34 in either direction. A flexible coupler 214 may couple the shaft 216 of the motor 32 to one end of the screw 34 to transfer the torque from the motor 32 to the screw 34. As the motor 32 rotates the screw 34, the sleeve 38 may move along the longitudinal axis of the screw 34 to extend or retract the distal end 40 of the link 22 relative to the reference plane 18.

FIG. 3 shows a cross-sectional side view of the mounting system 10 in a retracted position. The screw 34 and links 22 and 24 may be arranged to minimize the distance D between the reference plane 18 and the mounting surface 20. As the motor 32 turns the screw 34 to move the sleeve 38 in the positive Y-axis direction, the sleeve 38 applies force in the positive Y direction on the first link 22. The force on the link 22 causes the pivot point 204 to extend relative to the reference plane 18 substantially along the Z-axis with nominal, if any, movement along the Y-axis. In other words, if the reference plane 18 represents a wall, then the distal ends of the first link extend and retract is a substantially horizontal manner or along the XZ plane. This minimizes the torque needed from the motor 32 to extend or retract the weight of a monitor attached to the mounting surface 20 because the weight of the monitor is not lifted by the motor 32.

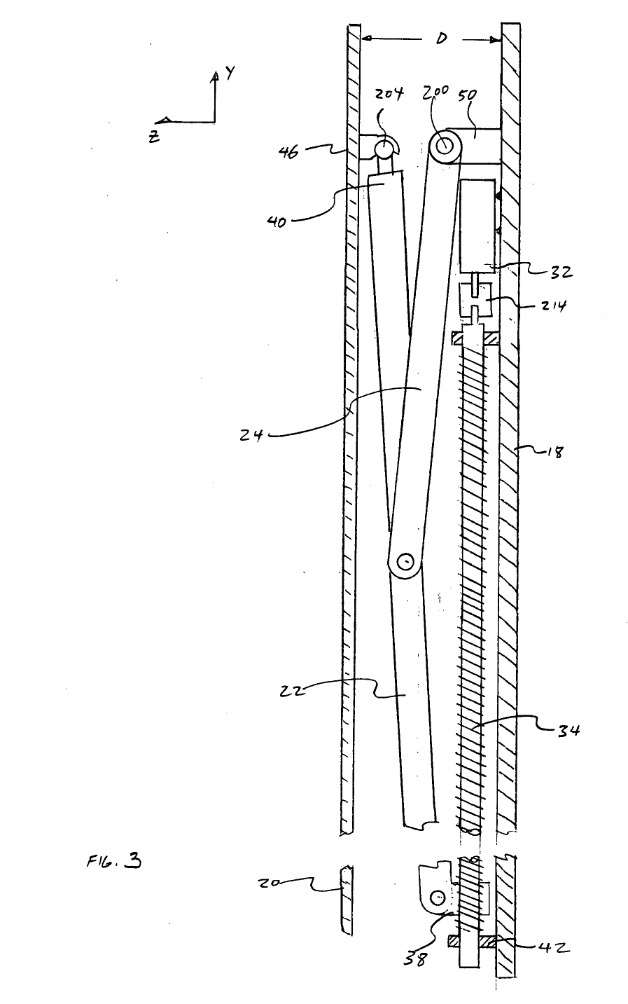

FIG. 4 shows a cross-sectional view of the link 24 along the line 4 shown in FIG. 2. The proximal end 28 of the second actuator 14 may be pivotally coupled to the hinge 50, and the distal end 26 of the link 24 may be pivotally coupled to the link 22 about the pivot point 212. The hinge 50 includes a pin 400 within a cylinder 402. In this example, the pin 400 may represent the pivot point 200. The pin 400 may be coupled to end caps 404 with the cylinder 402 between the end caps 404. The end caps 404 may be mounted to the reference plane 18. The longitudinal axis of the pin 400 may be substantially along the X-axis to allow the cylinder 402 to rotate or pivot about the X-axis. The pin 400 and the cylinder 402 may have a length X to resist the bending load applied to the cylinder. As such, with the above hinge 50 and link 24 configurations, the second actuator 14 may be substantially prevented from moving laterally in the X-axis direction so that the distal end 40 of the second actuator 14 moves substantially in a perpendicular manner relative to the reference plane 18, and the distal ends 40 of the first and third actuators 12 and 16 may extend or retract substantially along XZ plane or horizontal or a common plane.

The distal end 26 of the second link 24 may have a cut out 406 defined by two flanges 408 adapted to receive the link 22 between the two flanges 408. The pivot point 212 may be represented as a pin to pivotably couple the link 22 to the two flanges 408. The cut out 406 may have a sufficient gap to allow the link 22 to pivot within the cutout 406.

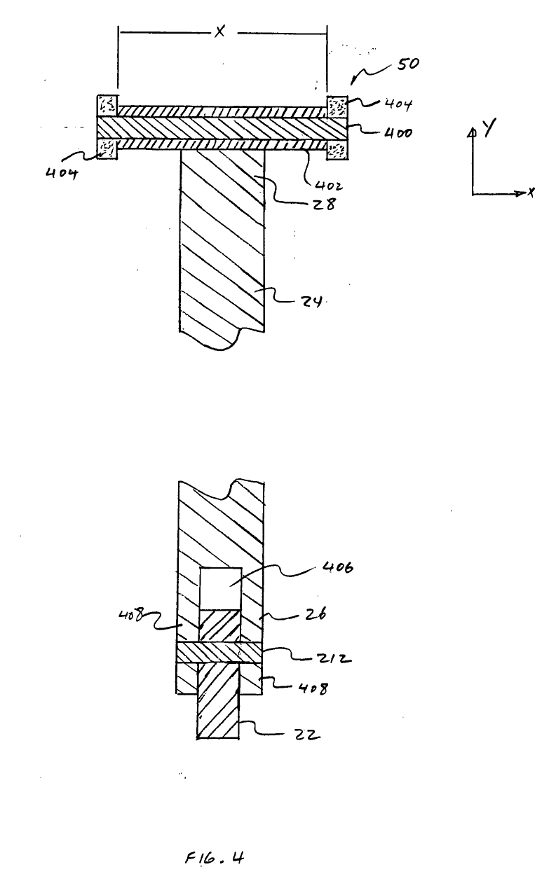

FIGS. 5 and 6 show the proximal ends 28 of the second link 24 for the first and third actuators 12 and 16 pivotally coupled to their respective universal pivot joints 30. The proximal end 28 of the second link 24 may have two legs 500 adapted to receive a flange 502 therebetween. The two legs 500 and the flange 502 may be pivotably coupled to each other through a pin 504 to allow the proximal end 36 of the link 24 to pivot about the X-axis.

FIG. 6 shows a cross-sectional view of the universal pivot joint 30 along the line 6 in FIG. 5. The universal pivot joint 30 has a pin 600 within a cylinder 602. The pin 600 may be coupled to end caps 604 with the cylinder 602 between the end caps 604. The end caps 604 may be mounted to the reference plane 18. The longitudinal axis of the pin 600 may be substantially along the Y-axis to allow the cylinder 602 to rotate or pivot about the Y-axis. As such, as the mounting system 10 swivels the mounting surface 20 along the XZ-plane, the second links 24 for the first and third actuators 12 and 16 may pivot about their respective universal pivot joints 30 along the Y-axis.

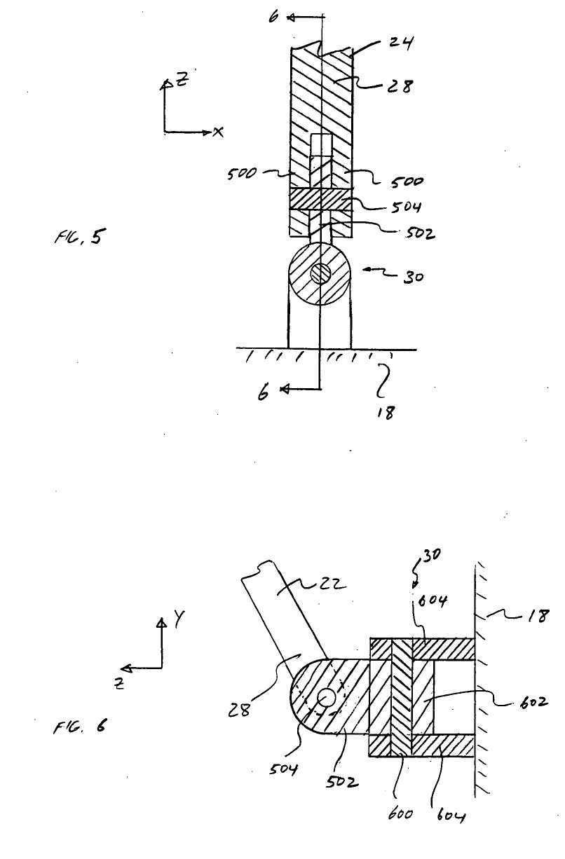

FIG. 7 shows a bracket system 700 adapted to pivotally couple the distal ends 40 of the first, second, and third actuators 12, 14, and 16 to their respective locations 44, 46 and 48 on the mounting surface 20. The bracket system 700 includes a first bar 702 and a second bar 704 supported by a first bracket 706 and a second bracket 708. A third bracket 710 may be provided between the first and second brackets 706 and 708, and the third bracket 710 may be adapted to receive the first and second bars 702 and 704. A fourth bracket 712 may be provided between the second and third brackets 708 and 710; and a fifth bracket 714 may be provided between the first and third brackets 706 and 710. The fourth and fifth brackets 712 and 714 may be adapted to pivotally couple to the rotatable joints 206 at the locations 44 and 48 on the mounting surface 20. The third bracket 710 is adapted to pivotally couple the rotatable joint 206 at the location 46 on the mounting surface 20; and as discussed in more detail below, the rotatable joint 206 at the location 46 may slide along the Y-axis when the mounting surface 20 is being tilted.

The first and second brackets 706 and 708 may have one or more holes 716 adapted to receive one or more bolts that tighten with the provisions made in the mounting surface 20 such as threaded openings. The first and second brackets 706 and 708 may slide along the first and second bars 702 and 704 so that the bracket system 700 may be mounted to the mounted surface having the threaded openings in a variety of locations. This enables the mounting system 10 to be mounted to the mounting surface 20 so that the mounting system 10 may reposition the mounting surface 20 relative to the reference plane 18.

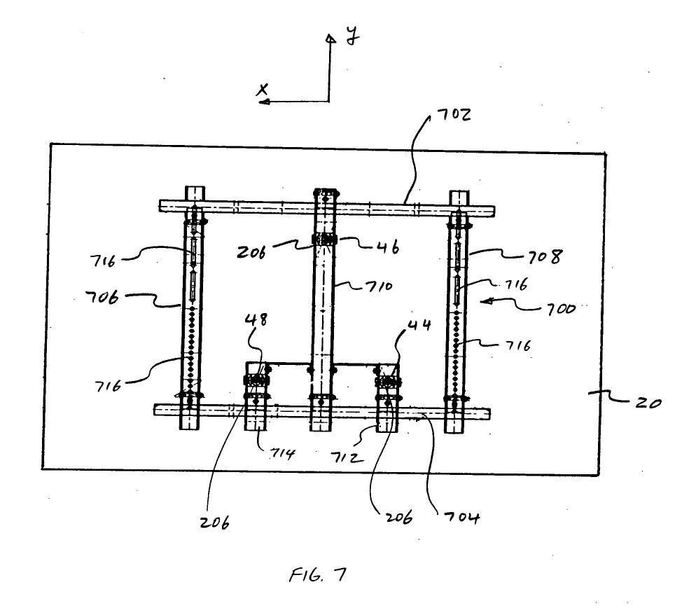

FIG. 8 shows a rotatable joint 206 that may be used to pivot the distal ends 40 of the first, second, and third actuators 12, 14, and 16. The rotatable joint 206 includes a socket 800 adapted to house a round head 802. The round head 802 may also have a threaded portion 804 that attaches to the distal end 40 of the first link 22. FIG. 9 shows that the socket 800 may have a circular cavity 900 that allows the round head 802 to rotate therein. The socket 800 may have threaded openings 902 adapted to receive bolts to attach the rotatable joint 206 to the third, fourth, and fifth brackets 710, 712, and 714 at their respective locations 44, 46, and 48, as discussed above. The rotatable joint 206 may be coupled to their respective brackets such that the rotatable joint 206 may pivot about the longitudinal axis of the threaded opening 902.

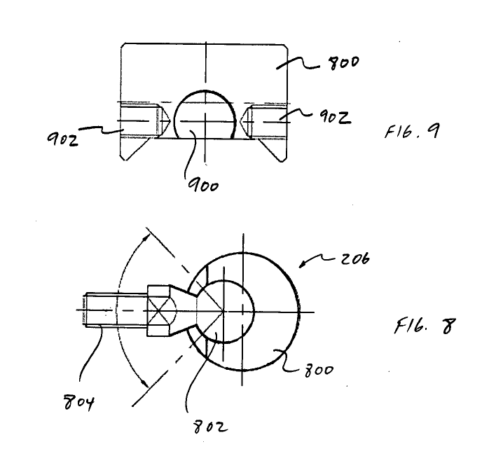

As an example, the mounting surface 20 may be the backside of a monitor in order to adjust the viewing angle of the monitor with the convenience of a remote control. FIG. 10 is a perspective view of the bracket system 700 attached to the backside of the monitor 1000. The third bracket 710 may have an elongated slot 1002 at one end adapted to receive the rotatable joint 206 and allow the pivot joint 902 to slide along the elongated slot 1002. This allows the distal end 40 of the second actuator to slide along the elongated slot 1002 as the mounting system 10 tilts the monitor 1000 up or down. The rotatable joints 206 coupled to the fourth and fifth brackets 712 and 714 may rotate about their respective longitudinal axis of the threaded opening 902 but may not slide. As such, the distal ends of the first, second, and third actuators 12, 14, and 16 may rotate about their respective locations 44, 46, and 48, and the rotatable joint 206 for the second actuator at the location 46 may slide along the elongated slot 1002. Alternatively, the elongated slots may be provided at the fourth and fifth brackets 712 and 714 and not at the third bracket 710 so that the distal ends of the first and third brackets slide along the fourth and fifth brackets and not at the third brackets. Note that it is within the scope of this invention to utilize a variety of bracket systems know to one skilled in the art. For instance, the mounting bracket 10 may be first attached to a wall and then the monitor 1000 may be attached to the bracket system 700.

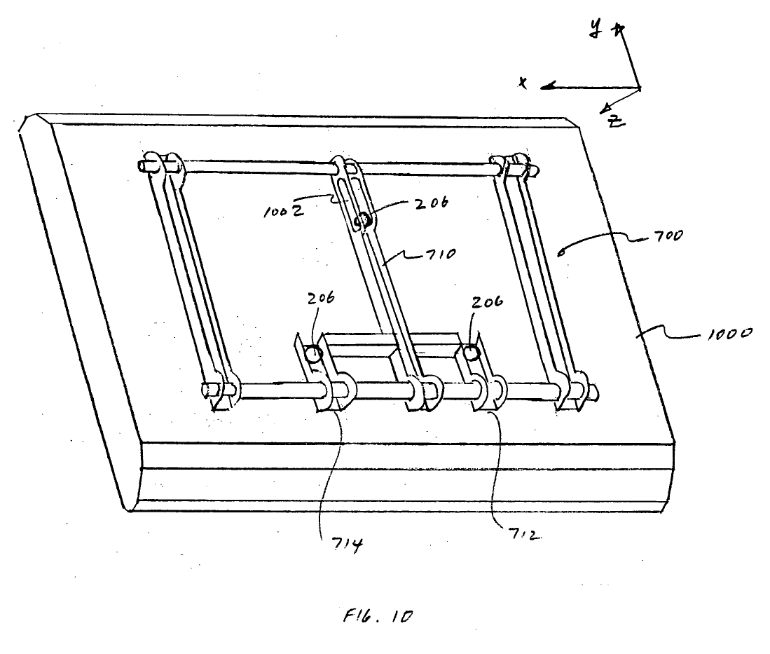

FIGS. 11 and 12 show a schematic side view of the mounting system 10 to illustrate that the rotatable joint 206 for the second actuator 14 slides along the elongated slot 1002 when the mounting system 10 tilts the mounting surface 20. FIG. 11 shows the mounting surface 20 tilted in a counter-clockwise direction from a first position 1100 to a second position 1102 along the YZ-plane by extending the second actuator 14 further relative to the first and third actuators 12 and 16. In the first position 1100, the distal end 40 of the second actuator 14 is located at a location 1104; and in the second position, the distal end 40 of the second actuator 14 is located at a location 1106, which is in the positive Z direction with nominal, if any, movement in the X and Y axes. As such, the distance between the distal end 40 of the second actuator 14 and the distal ends of the first and third actuators 12 and 16 is longer in the second position 1102 than in the first position 1100. Likewise, FIG. 12 shows that when the mounting surface 20 is tilted in a clockwise direction from the first position 1100 to a third position 1200, the distance between the distal end 40 of the second actuator 14 and the distal ends of the first and third actuators 12 and 16 is longer in the second position 1200 than in the first position 1100.

In reference to FIG. 10, to allow the distal end 40 of the second actuator 14 to vary the distance between the distal ends 40 of the first and third actuators 12 and 16, and the distal end 40 of the second actuator 14 the rotatable joint 206 for the second actuator 14 is able to slide along the elongated slot 1002 of the third bracket 710. In this regard, the weight of the monitor 1000 is substantially supported by the first and third actuators 12 and 16; and the second actuator 14 may be extended or retracted relative the first and third actuators 12 and 16 or vice versa to tilt the monitor 1000 in the YZ plane.

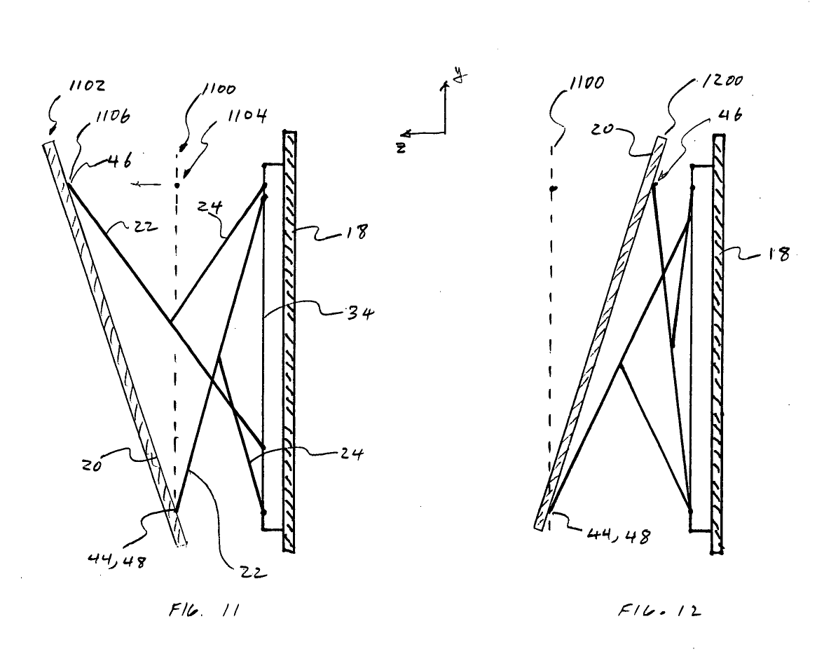

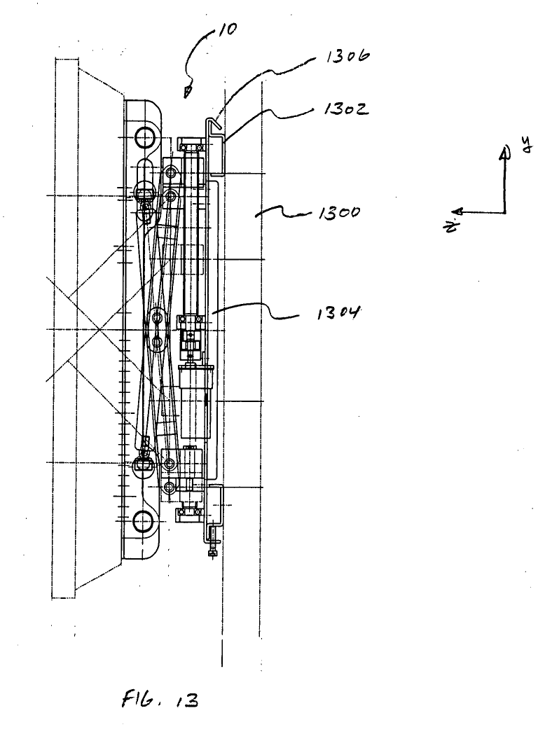

FIG. 13 shows a side view of the mounting system 10 in a retracted position. To couple the mounting system 10 to wooden studs 1300 within a wall, a wall bracket 1302 may be provided between the reference plane 18 and the wall where the mounting system 10 may be mounted. The wall bracket 1302 may be adapted to mount to the wooden studs 1300 within the wall. The wall bracket 1302 may have a plurality of holes so that at least a portion of the holes align with the wooden studs 1300, which are about 16 inches apart center to center, so that screws may be used to mount the wall bracket 1302 to the wall. Once the wall bracket 1302 is mounted to the wall, a base plate 1304, representing the reference plane 18, having one or more hooks 1306 may be placed over the wall bracket 1302 to attach the base plate 1304 to the wall bracket 1302.

FIG. 14 shows a side view of the mounting system 10 where the monitor 1000 is in a tilt upward position or in a clockwise direction along the YZ plane by extending the first and third actuators 12 and 16 further away from the base plate 1304 relative to the second actuator 14 along the Z-axis. Conversely, FIG. 15 shows the mounting system 10 where the monitor 1000 is in a tilt downward position or counter-clockwise direction along the YZ plane by extending the second actuator 14 from the base plate 1304 further along the Z-axis relative to the first and third actuators 12 and 16. Note that in FIGS. 14 and 15, the rotatable joint 206 is located at the upper part of the elongated slot 1002 indicating that the distance between the distal end 40 of the second actuator 14 is further away from the distal ends 40 of the first and third actuators 12 and 16 compared to when the monitor 1000 is substantially parallel with the base plate 1304.

Once the viewing angle of the monitor 1000 is fixed, the weight of the monitor 1000 coupled to the mounting system 10 is substantially carried by the three actuators 12, 14, and 16 as compression or tension load. As beams are better able to carry compression and tension loads versus bending loads, the mounting system 100 is able to carry more weight. For instance, referring back to FIG. 15, the center of gravity of the monitor 1000 attached to the mounting system 10 may be at a location 1500. The combined weight “W” of the monitor 1000 and the mounting system 10 is transferred to three actuators 12, 14, and 16. In this example, the first links 22 for the three actuators 12, 14, and 16 will be generally under tension load. That is, with the first links 22 having rotatable distal ends, there are minimal, if any, bending and/or torque loads on the first links. This allows the mounting system 10 to move the monitor 1000 further away from the first mounting surface 102 along the Z-axis without overstressing the first links 22.

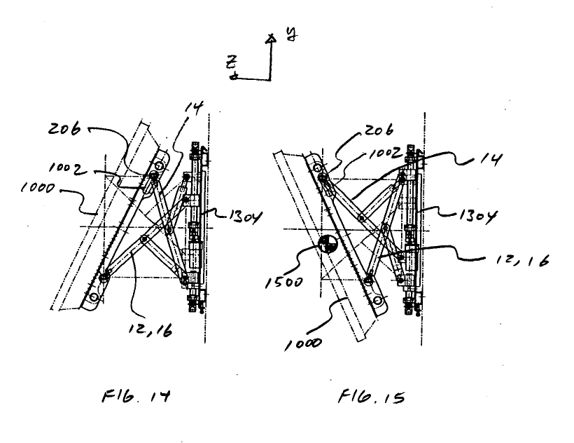

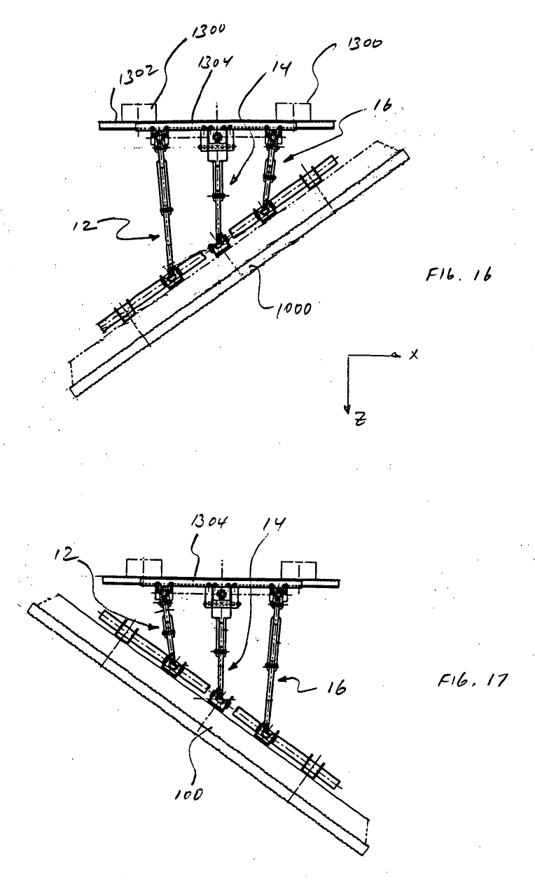

FIG. 16 shows a top view of the mounting system 10 where the monitor 1000 is swiveled to the right side or in a counter-clockwise direction along the XZ plane by extending the first actuator 12 further from the base plate 1304 than the third actuator 16 along the Z-axis. FIG. 16 also shows the back plate 1302 mounted to the two wooden studs 1300, and the base plate 1304 hooked onto the back plate 1302. Conversely, FIG. 17 shows the mounting system 10 where the monitor 1000 in swiveled to the left side or in a clockwise direction along the XZ plane by retracting the first actuator 12 closer to the base plate 1304 relative to the third actuator 16. In addition, the second actuator 14 may be extended or retracted relative to the base plate 1304, as discussed in references to FIGS. 14 and 15, to tilt the monitor downward or upwards, respectively, along with the swivel movements.

Referring back to FIG. 1, the direction of the gravitational force may be in the negative Y-direction. The mounting system 10, however, may also operate with the direction of the gravitational force in the positive Y-direction. In this regard, FIG. 18 shows a disassembled perspective view of the mounting system 10 where the three actuators 12, 14, and 16 are inverted relative to the three corresponding actuators shown in FIG. 1 in reference to the X, Y, and Z axes. As such, in FIG. 1, the first link 22 of the second actuator 14 forms a positive slope from its proximal end to the distal end, whereas in FIG. 18, the first link 22 of the second actuator 14 forms a negative slope from its proximal end to the distal end. Again, the three actuators 12, 14, and 16 are substantially similar, except that the second link 24 for the second actuator 14 may be different from the second link for the first and third actuators 12 and 16, as discussed above in reference to FIG. 4.

FIG. 18 shows the first actuator 12 with the first link 22 adapted to pivotally couple to the second link 24 about its midpoint 212. The distal end 40 of the first link 22 is adapted to couple to the round head 208 which is adapted to rotate within the socket 210. The proximal end 28 of the first link 22 is adapted to pivotally couple to the sleeve 38. The proximal end 36 of the second link 24 may be pivotally coupled to the universal pivot joint 30. The sleeve 38 may have a threaded opening to receive the screw 34 so that the sleeve may move along the longitudinal axis of the screw 34. The screw 34 is supported by two support brackets 42 which attach to the base plate 1304. Within each of the support brackets 42 may be a bearing 1800 to smoothly rotate the screw 34. The coupler 214 may couple one end of the screw 34 to the shaft of the motor 32, which is attached to the base plate 1302 through a motor bracket 1802. A limit switch 1808 may be provided on the opposite end of the screw 34 to detect if the sleeve 38 has reached its limitation.

FIG. 18 shows the wall bracket 1302 with a plurality of holes adapted to receive screws that insert into wooden studs or a concrete wall. The base plate 1304 has one or more hooks 1306 that fit over the wall bracket 1302 to attach the mounting system 10 to a wall for example. The bracket system 700 is adapted to pivotally couple to the distal ends of the three actuators 12, 14, and 16, as discussed above in reference to FIG. 7. The first and second brackets 706 and 708 are adapted to slide along the first and second bars 702 and 704 and they have plurality of holes 1806 to attach to the back side of a monitor. A control box 1810 may be provided on the base plate 1304 to control the operation of the three actuators 12, 14, and 16 to swivel and/or tilt the monitor, as discussed in more detail below.

A flexible enclosure 1812 may be provided between the base plate 1304 and bracket system 700 to substantially enclose the three actuators 12, 14, and 16 to substantially prevent foreign objects from interfering with the movement of the three actuators. The proximal end 1814 of the flexible enclosure 1812 may be attached to the base plate 1304. The distal end 1816 of the flexible enclosure 1812 may be coupled to the first and second bars 702 and 704 so that the distal end 1816 of the flexible enclosure 1812 may be slide side to side along the longitudinal axis of the first and second bars. In addition, the distal end 1816 of the flexible enclosure may slide up and down to allow the flexible enclosure to fold uniformly when the mounting system 10 swivels and/or tilts a monitor. Audio and video wires may be passed through the flexible enclosure so that wires do not show between the base plate 1304 and the bracket system 700.

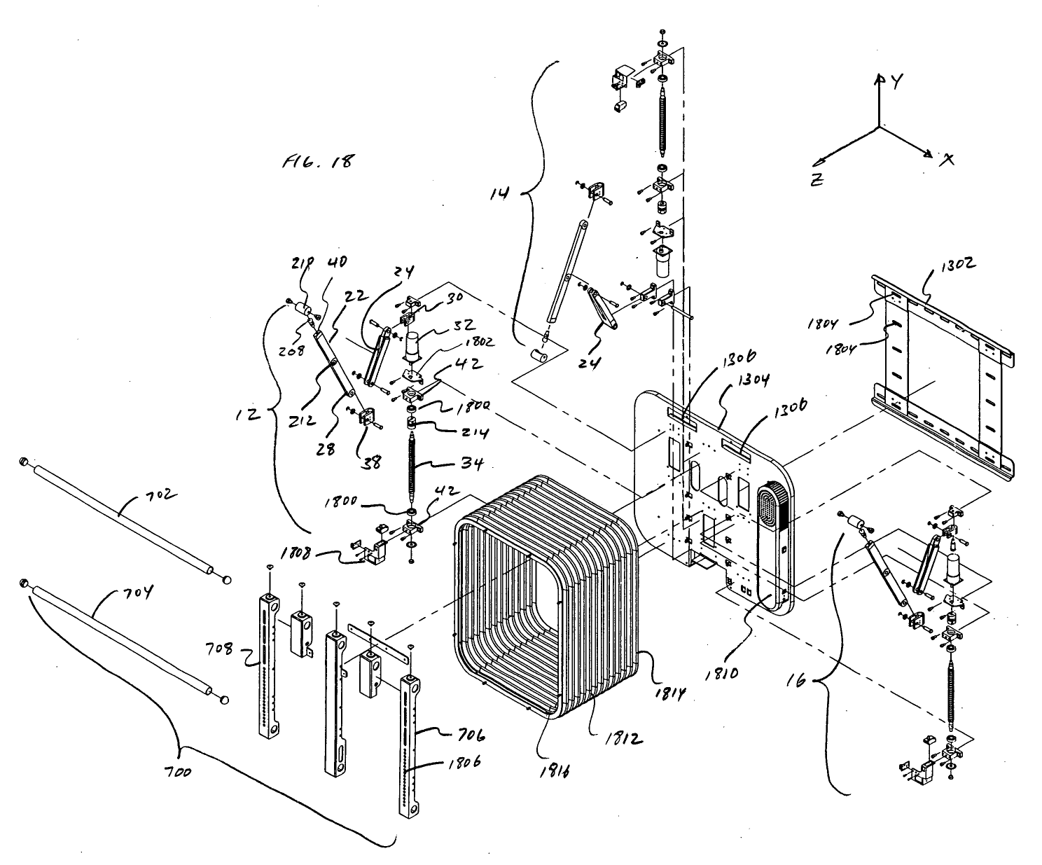

FIG. 19 shows a side view of a sliding mechanism 1900 adapted to couple the distal end 1816 of the flexible enclosure 1812 to the first and second bars 702 and 704. The sliding mechanism 1900 may include a hook beam 1902 with two hook ends 1904 and 1906 adapted to slideably couple to the first and second bars 702 and 704, respectively, along their longitudinal axes. The hook beam 1902 has one or more openings 1908 and 1910. The two openings 1908 and 1910 may be elongated along the longitudinal axis of the hook beam 1902. The sliding mechanism 1900 may also include a sliding beam 1912 adapted to couple the distal end 1816 of the flexible enclosure 1812 to the hook beam 1902. The sliding beam 1912 may have coupling elements 1914 and 1916 adapted to pass through the openings 1908 and 1910, respectively, and slide along the elongated openings 1908 and 1910. The coupling element may protrude from the sliding beam 1912 to slide along the corresponding elongated opening. The proximal end 1814 of the flexible enclosure 1812 may be coupled to the base plate 1304.

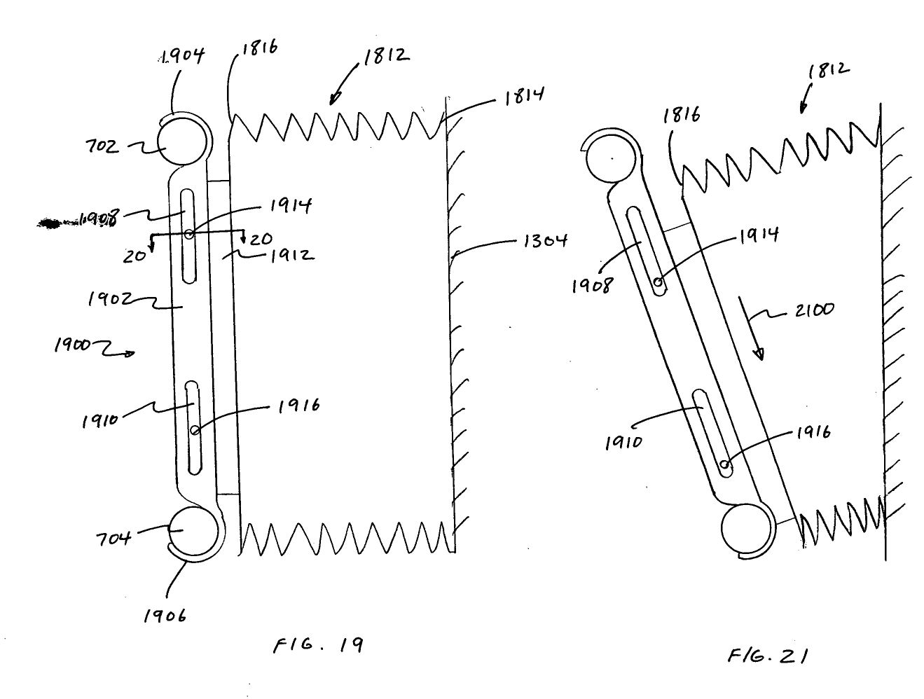

FIG. 20 shows a cross-sectional view of the sliding mechanism 1900 along the line 20. The sliding beam 1912 may have an “L” shape configuration with one or more coupling elements 2000 adapted to couple the sliding beam 1912 to the distal end 1816 of the flexible enclosure 1812. As such, the distal end 1816 of the flexible enclosure 1812 may be substantially free to slide along the longitudinal axis of the hook beam 1902 to reduce crimpling along the flexible enclosure 1812 as the monitor is tilted.

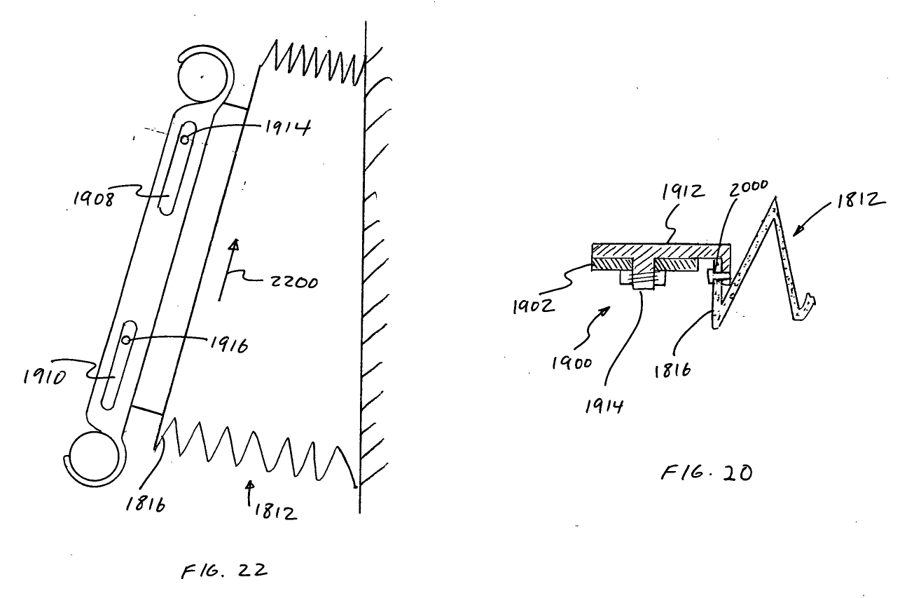

FIG. 21 shows the flexible enclosure 1812 in a tilted downward position. As the flexible enclosure. 1812 is moved from the upright position, as shown in FIG. 19, to the tilted downward position, as shown in FIG. 21, the natural tendency of the distal end 1816 of the flexible enclosure 1812 is to slide downward along the hook beam 1902, as indicated by the direction arrow 2100. As such, the coupling elements 1914 and 1916 slide downward along the elongated openings 1908 and 1910 to minimize the resistance by the flexible enclosure 1812 to tilt downward and to minimize the flexible enclosure 1812 from crimpling. Conversely, FIG. 22 shows the distal end 1816 of the flexible enclosure 1812 sliding upwards, as indicated by the direction arrow 2200, along the elongated openings 1908 and 1910 as the flexible enclosure 1812 is tilted upwards.

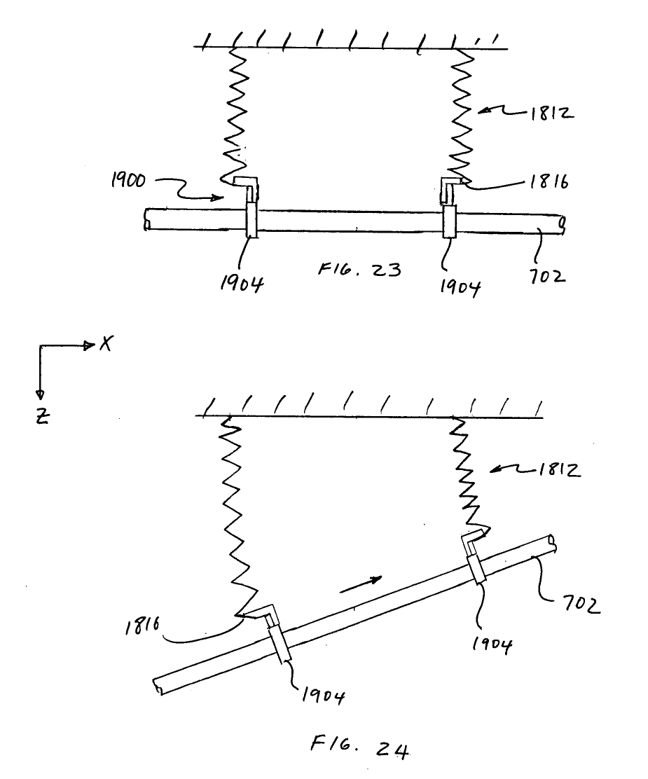

FIG. 23 shows the sliding mechanism 1900 along the XZ-plane, where the hook ends 1904 and 1906 (not shown) may be used to couple the distal end 1816 of the flexible enclosure 1812 to the first bar 702 and the second bar 704 (not shown), respectively. FIG. 24 shows that as the motorized mount swivels the monitor to the right side, the hook ends 1904 and 1906 are able to slide along the first and second bars 702 and 704 to minimize the resistance by the flexible enclosure 1812 to the swivel movement and to minimize the flexible enclosure 1812 from crimpling.

While various embodiments of the invention have been described, it will be apparent to those of ordinary skill in the art that many more embodiments and implementations are possible within the scope of this invention. For instance, in reference to FIG. 1, additional actuators may be added to the base based plate 1304 to support heavier monitors if necessary. Accordingly, the invention is not to be restricted except in light of the attached claims and their equivalents.

What is claimed is:

1. An enclosure system for a motorized mount adapted to adjust a viewing angle of a monitor having a back side, the enclosure system comprising:
a base plate adapted to couple to a wall;
at least one beam adapted to associate with the back side of the monitor as the motorized mount adjusts the viewing angle of the monitor; and
an enclosure having a proximal end and a distal end, the enclosure adapted to substantially enclose at least one motorized actuator of the motorized mount, the proximal end adapted to couple to the base plate, and the distal end adapted to slide vertically along a longitudinal axis of the at least one beam.

2. The enclosure system according to claim 1, where the motorized mount includes a first bar and a second bar adapted to couple to the back side of the monitor, the at least one beam having a first hook and a second hook adapted to slidably couple to the first and second bars, respectively, to allow the first and second hooks to slide relative along their respective first and second hooks as the motorized mount swivels the monitor.

3. The enclosure system according to claim 1, including a sliding beam coupled to the distal end of the enclosure, the sliding beam having a protruding element, the at least one beam having at least one elongated opening adapted to receive the protruding element to allow the protruding element to slide along the at least one elongated opening as the motorized mount tilts the monitor.

4. A method of enclosing at least one actuator of a motorized mount system with a flexible enclosure, the motorized mount system adapted to couple the back side of the monitor to a wall, the method comprising:
coupling a proximal end of the flexible enclosure to a base plate adapted to couple to the wall;
sliding a distal end of the flexible enclosure horizontally along the back side of the monitor as the motorized mount system swivel the monitor; and
sliding the distal end of the flexible enclosure vertically along the back side of the monitor as the motorized mount system tilts the monitor.
